(19) United States
(12) Patent Application Publication
(10) Pub. No.: US 2025/0150994 A1
(43) Pub. Date: May 8, 2025

(54) COMMUNICATION APPARATUS, METHOD OF CONTROLLING COMMUNICATION APPARATUS, AND STORAGE MEDIUM

(71) Applicant: CANON KABUSHIKI KAISHA, Tokyo (JP)

(72) Inventor: TETSUYA YAMAMOTO, Kanagawa (JP)

(21) Appl. No.: 19/014,810

(22) Filed: Jan. 9, 2025

Related U.S. Application Data
(63) Continuation of application No. PCT/JP2023/023255, filed on Jun. 23, 2023.

(30) Foreign Application Priority Data
Jul. 11, 2022 (JP) 2022-111105

(51) Int. Cl. H04W 56/00; H04W 92/18

(52) U.S. Cl. CPC H04W 56/001; H04W 92/18

(57) ABSTRACT

A communication apparatus includes a detection unit configured to detect at least one different communication apparatus capable of serving as a synchronization source and capable of performing sidelink communication, an acquisition unit configured to acquire predetermined information from each of the at least one different communication apparatus detected by the detection unit, and a first setting unit configured to, in a case where a predetermined operation setting regarding a synchronization priority order has been made and the first setting unit determines that there is a different communication apparatus from which information indicating that the different communication apparatus is a predetermined type of communication apparatus that is to serve as the synchronization source has been acquired, among the at least one different communication apparatus, based on the predetermined information acquired by the acquisition unit, set the different communication apparatus from which the information has been acquired as a time synchronization source.

### CROSS-REFERENCE TO RELATED APPLICATIONS

This application is a Continuation of International Patent Application No. PCT/JP2023/023255, filed Jun. 23, 2023, which claims the benefit of Japanese Patent Application No. 2022-111105, filed Jul. 11, 2022, both of which are hereby incorporated by reference herein in their entirety.

### BACKGROUND OF THE INVENTION

### Field of the Invention

The present invention relates to a communication apparatus, a method of controlling the communication apparatus, and a storage medium.

### Background Art

In a terminal-to-terminal direct communication method called PC5 communication or sidelink communication in a 3GPP standard, synchronization is achieved with a signal from a terminal that is synchronized with absolute time as accurate as possible to achieve synchronization in transmission/reception timing between terminals. The PC5 communication terminal utilizes, for example, a public wireless base station or a global navigation satellite system (GNSS) (Patent Literature 1). The 3GPP (registered trademark) stands for Third Generation Partnership Project.

### CITATION LIST

### Patent Literature

PTL 1: Japanese Unexamined Patent Application Publication 2018-525894

In a PC5 network (sidelink communication network) including fixed user equipment and movable user equipment based on the assumption of being not synchronized with the public wireless base station or the GNSS, a PC5 communication terminal (user equipment) with the highest signal intensity is selected as a synchronization source. However, in a case where the user equipment merely having a high signal intensity serves as the synchronization source, a signal intensity changes depending on a relative positional relationship with an apparatus, which leads to a frequent change of synchronization source equipment. The frequent change of the synchronization source equipment makes it difficult to achieve stable synchronization in the whole network.

### SUMMARY OF THE INVENTION

In consideration of the above-mentioned issue, the present invention is directed to provision of a communication apparatus capable of achieving stable synchronization in a network that adopts a sidelink communication method.

To achieve the above-mentioned objective, according to an aspect of the present invention, a communication apparatus capable of performing sidelink communication includes a detection unit configured to detect at least one different communication apparatus capable of serving as a synchronization source and capable of performing sidelink communication, an acquisition unit configured to acquire predetermined information from each of the at least one different communication apparatus detected by the detection unit, and a first setting unit configured to, in a case where the information acquired by the acquisition unit indicates that the different communication apparatus is a predetermined type of communication apparatus that is to serve as the synchronization source, set the different communication apparatus from which the information has been acquired as a time synchronization source.

### Advantageous Effects of Invention

Further features of the present invention will become apparent from the following description of exemplary embodiments with reference to the attached drawings.

### BRIEF DESCRIPTION OF THE DRAWINGS

FIG. 1 is a block diagram illustrating a communication apparatus according to a first exemplary embodiment of the present invention.

FIG. 2 is a functional block diagram of the communication apparatus illustrated in FIG. 1.

FIG. 3 is a diagram illustrating a network including the communication apparatus illustrated in FIG. 1.

FIG. 4 is a functional block diagram in a case where the communication apparatus is a communication apparatus that is installed in a fixed manner.

FIG. 5 is a diagram illustrating an example of an information element indicating a type of the communication apparatus.

FIG. 6 is a flowchart executed by the communication apparatus in the first exemplary embodiment.

FIG. 7 is a diagram illustrating an example of an information element indicating a prioritized synchronization destination.

FIG. 8 is a flowchart executed by the communication apparatus in a second exemplary embodiment.

### DESCRIPTION OF THE EMBODIMENTS

Modes for implementing the present invention will be described in detail below with reference to the accompanying drawings. Note that exemplary embodiments described below are merely examples of a means for implementing the present invention, and should be modified or changed as appropriate depending on a configuration of an apparatus to which the present invention is applied and various kinds of conditions, and the present invention is not limited to the exemplary embodiments described below.

### First Exemplary Embodiment

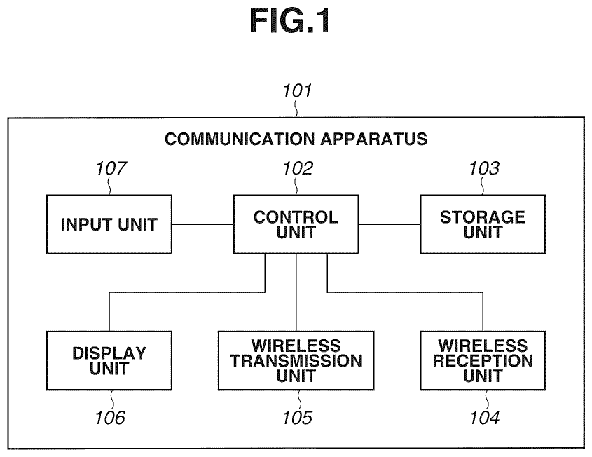

FIG. 1 is a block diagram illustrating an example of a configuration of a communication apparatus 101 according to an exemplary embodiment of the present invention.

The communication apparatus 101 includes a control unit 102, a storage unit 103, a wireless reception unit 104, a wireless transmission unit 105, a display unit 106, and an input unit 107. The communication apparatus 101 is a communication apparatus that is capable of performing communication using a terminal-to-terminal direct communication method called PC5 communication or sidelink communication in a Third Generation Partnership Project (3GPP) standard. Note that the communication apparatus 101 may be hereinafter referred to as a communication terminal apparatus or a terminal.

The control unit 102 executes a control program stored in the storage unit 103 to control the whole of the communication apparatus 101. The control unit 102 is composed of one or a plurality of CPUs or one or a plurality of MPUs. The control unit 102 is capable of executing an operating system (OS), a driver, an application, and the like. The CPU stands for a central processing unit. The MPU stands for a micro-processing unit. The control unit 102 includes a built-in clock. Note that the control unit 102 may include a graphics processing unit (GPU).

The storage unit 103 stores the control program to be executed by the control unit 102. Additionally, the storage unit 103 stores various kinds of information such as communication parameters and captured image data. Various kinds of operations to be described below are performed by the control unit 102 executing the control program stored in the storage unit 103.

The storage unit 103 includes, for example, a ROM that stores the control program, and a RAM that functions as a work area to be used when the control unit 102 executes a program or the like read out from the ROM. The communication parameters and captured image data (image files) are stored in the RAM.

The ROM stands for a read only memory. The RAM stands for a random access memory.

The wireless reception unit 104 receives a PC5 signal and a GNSS signal in the 3GPP standard.

The wireless transmission unit 105 transmits a PC5 signal in the 3GPP standard.

The display unit 106 displays characters, images, and the like. The display unit 106 includes an LCD or LEDs, and outputs visually recognizable information (visual information). Note that the display unit 106 may include a speaker or the like and output audibly recognizable information (sound information). The LCD stands for a liquid crystal display. The LED stands for a light emitting diode. The display unit 106 may include, for example, a screen touch sensor, which enables a user's operation of an application via a GUI. The GUI stands for a graphic user interface.

The input unit 107 is used when the user performs various kinds of input or the like to the communication apparatus 101. The input unit 107 includes, for example, a mouse and a keyboard, or a touch panel and the like, all of which are not illustrated, and acquires (accepts) the user's input via these devices.

Note that the communication apparatus 101 may include a distance sensor (not illustrated) that measures a distance to another communication apparatus.

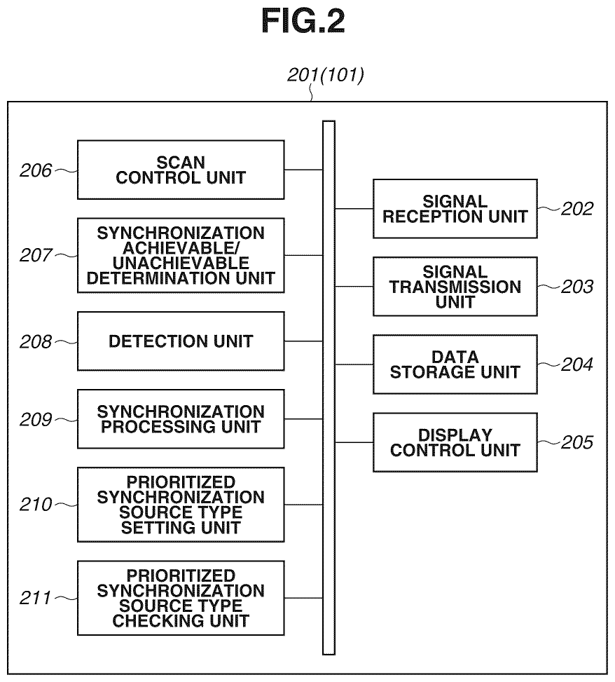

FIG. 2 is a block diagram illustrating an example of a software functional configuration 201 of the communication apparatus 101.

The software functional configuration 201 includes a signal reception unit 202, a signal transmission unit 203, a data storage unit 204, a display control unit 205, and a scan control unit 206. Additionally, the software functional configuration 201 includes a synchronization achievable/unachievable determination unit 207, a detection unit 208, a synchronization processing unit 209, a prioritized synchronization source type setting unit 210, and a prioritized synchronization source type checking unit 211.

The signal reception unit 202 executes reception of a PC5 signal and a GNSS signal. The signal reception unit 202 acquires notification information to be described below. The signal transmission unit 203 executes transmission of a PC5 signal. The data storage unit 204 stores and retains software and information such as authentication information.

The display control unit 205 executes control processing of a screen to be displayed on the display unit 106.

The scan control unit 206 performs scanning (detection) regarding whether synchronization reference equipment for achieving synchronization in the physical layer of a PC5 signal (a different communication apparatus that can serve as a synchronization source) exists in the surroundings.

The synchronization achievable/unachievable determination unit 207 determines whether it is possible to achieve synchronization with one or more pieces of (at least one piece of) synchronization reference equipment that can be obtained from a result of scanning by the scan control unit 206.

The detection unit 208 detects a fixed communication apparatus to be described below and different synchronization reference equipment among the synchronization reference equipment detected (found) by scanning by the scan control unit 206. The fixed communication apparatus is a communication apparatus (terminal) that is installed in a fixed and immovable manner.

The synchronization processing unit 209 determines whether synchronization will be achieved with the fixed communication apparatus to be described below or with the different apparatus based on a result of determination made by the synchronization achievable/unachievable determination unit 207 or a result of detection made by the detection unit 208.

The prioritized synchronization source type setting unit 210 sets a type of a synchronization source that should be referred to on a priority basis among types of the synchronization reference equipment. The prioritized synchronization source type setting unit 210 sets, for example, sl-SyncPriority indicating a prioritized synchronization source of the communication apparatus 101.

The prioritized synchronization source type checking unit 211 checks an information element indicating the type of the synchronization source that should be referred to on a priority basis for achieving synchronization in the physical layer.

Each functional component illustrated in FIG. 2 can be implemented by execution of a predetermined processing program by the control unit 102 (for example, a CPU) of the communication apparatus 101. Note that some of the functional components 202 to 211 in FIG. 2 may be collectively implemented as one functional component. Alternatively, one functional component may be divided into a plurality of functional components. Additionally, at least part of the functional components in FIG. 2 may be implemented with dedicated hardware. In a case where a functional component is implemented with hardware, for example, a dedicated circuit is only required to be automatically generated from a program for implementing each processing on an FPGA using a predetermined compiler. The FPGA stands for a field-programmable gate array. Alternatively, each functional component may be implemented as hardware by formation of a gate array circuit similarly to the FPGA. Still alternatively, each functional component may be implemented with an application-specific integrated circuit (ASIC). In this case, the hardware operates based on control of the control unit 102.

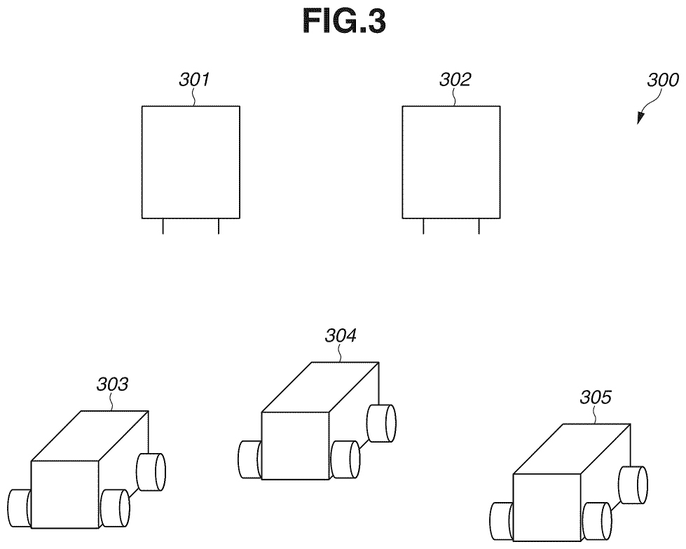

FIG. 3 is a diagram illustrating a network 300 including five communication apparatuses 101 described above. In the network 300 according to the present exemplary embodiment, the communication apparatuses 101 are, in a case of being installed in a fixed manner, fixed user equipment 301 and fixed user equipment 302, and are, in a case of being used as movable equipment, movable user equipment 303, movable user equipment 304, and movable user equipment 305. The fixed user equipment 301 and the fixed user equipment 302 may be referred to as fixed terminals. Each of the movable user equipment 303, the movable user equipment 304, the movable user equipment 305 is, for example, an autonomous vehicle that travels within a factory. The user equipment is hereinafter referred to as UE.

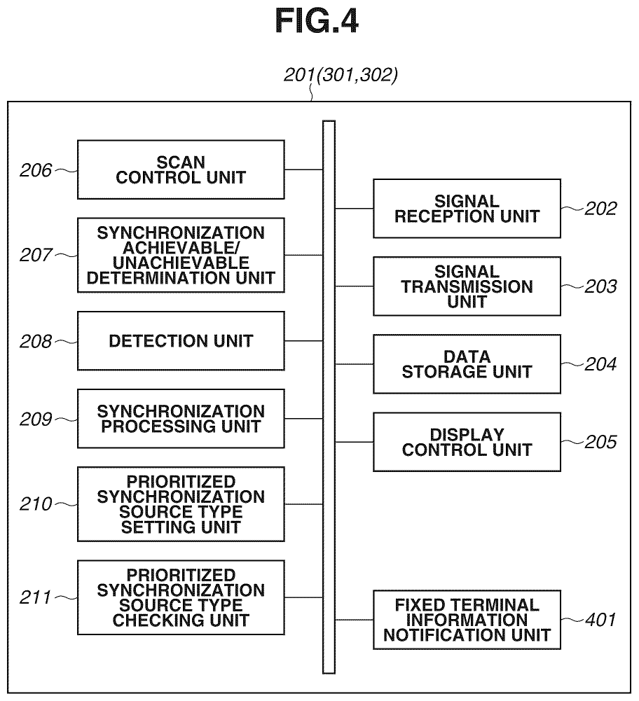

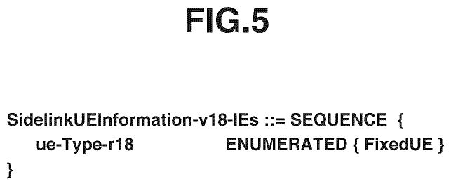

As illustrated in FIG. 4, each of the fixed UE 301 and the fixed UE 302 includes, in addition to the configuration in FIG. 2, a fixed terminal information notification unit 401. The fixed terminal information notification unit 401 gives (transmits) notification indicating that the fixed UE 301 and the fixed UE 302 each are a fixed terminal. Specifically, as illustrated in FIG. 5, the fixed terminal information notification unit 401 gives notification including information of FixedUE indicating a UE type in InformationElement (IE) to be notified by the fixed UE, which makes it possible for a different communication apparatus 101 to detect the fixed UE. The notification is performed with use of a beacon signal. The notification information transmitted from one piece of UE is received and acquired by the wireless reception unit 104 (signal reception unit 202) of different UE.

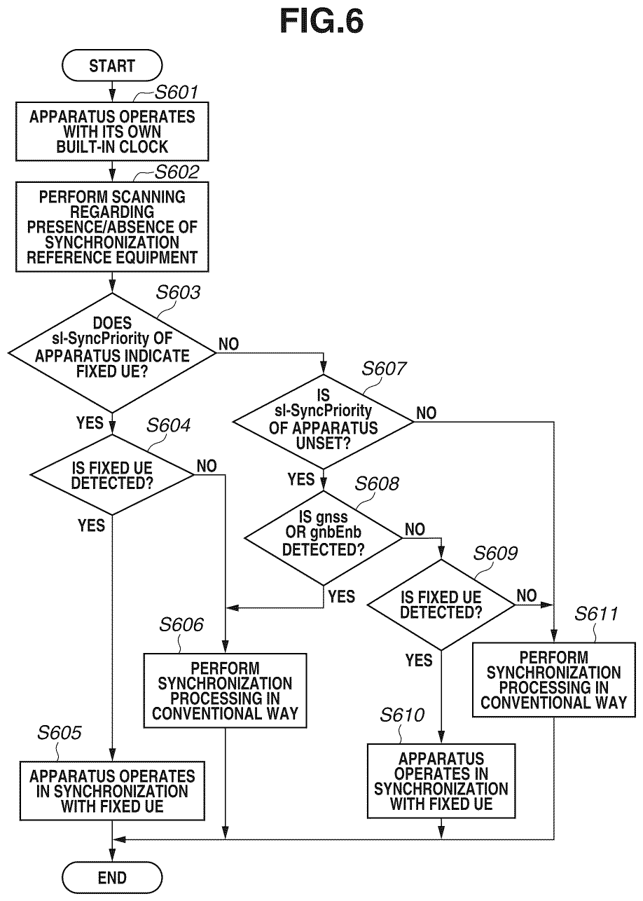

FIG. 6 is a flowchart for execution of processing of determining whether the movable UE 303, which is the communication apparatus 101 according to the present exemplary embodiment, is to be synchronized with the fixed UE 301. The flowchart in FIG. 6 is started by the control unit 102 of the movable UE 303, for example, when the network 300 is established or the movable UE 303 participates in the network 300. Alternatively, the flowchart in FIG. 6 may be started by the control unit 102 of the movable UE 303 when the movable UE 303 detects that a new communication apparatus has participated in the network 300. The flowchart in FIG. 6 is implemented by readout and execution of a computer program stored in the storage unit 103 by the control unit 102 of the movable UE 303. In the drawings, S is an abbreviation for Step.

When the processing in FIG. 6 is started, the movable UE 303 starts an operation with the built-in clock of the movable UE 303 (S601).

In S602 subsequent to S601, under control of the scan control unit 206, the movable UE 303 performs scanning regarding whether the synchronization reference equipment for achieving synchronization in the physical layer of the PC5 signal (the different communication apparatus that can serve as the synchronization source) exists in the surroundings. In the present exemplary embodiment, assume that the movable UE 303 detects the fixed UE 301 and the movable UE 304 as the synchronization reference equipment. That is, the scan control unit 206 detects the different communication apparatus that can serve as the synchronization source (the fixed UE 301 and the movable UE 304) within a predetermined range from the movable UE 303.

In S603 subsequent to S602, the movable UE 303 uses the prioritized synchronization source type checking unit 211 to determine whether sl-SyncPriority indicating a prioritized synchronization source for the movable UE 303 is Fixed UE indicating the fixed UE.

In a case where a result of determination in S603 is YES, the movable UE 303 uses the detection unit 208 to determine whether it has detected the fixed UE 301 (S604).

In a case where a result of determination in S604 is YES, the movable UE 303 uses the synchronization processing unit 209 to operate in synchronization with the fixed UE 301 (S605).

In a case where a result of determination in S604 is NO, the movable UE 303 performs known synchronization processing. That is, the movable UE 303 performs synchronization processing described in § 5.8.6.2 Selection and reselection of synchronisation reference in 3GPP TS 38.331 V16.7.0 (S606). Specifically, the movable UE 303 is synchronized with equipment that is not illustrated in FIG. 3 (for example, a public wireless base station).

By performing the above-mentioned processing, in a case where the movable UE 303 has a setting to be synchronized with the fixed UE on a priority basis (S603: YES) and in a case where the movable UE 303 detects the fixed UE 301 (S604: YES), the movable UE 303 can be synchronized with the fixed UE 301. In this manner, in a case where the movable UE 303 has a setting regarding the different communication apparatus that should be referred to on a priority basis (S603: YES), the fixed UE 301 is set as a time synchronization source on a priority basis over the public wireless base station and a satellite positioning system.

In contrast, in a case where a result of determination in S603 is NO, the movable UE 303 uses the prioritized synchronization source type checking unit 211 to determine whether sl-SyncPriority indicating the prioritized synchronization source for the movable UE 303 has been unset (S607).

In a case where a result of determination in S607 is NO, the processing proceeds to S611, and the movable UE 303 performs known synchronization processing. The synchronization processing in S611 is identical to that in S606.

In a case where a result of determination in S607 is YES, the movable UE 303 uses the detection unit 208 to determine whether it has detected gnss or gnbEnb (S608).

In a case where a result of determination in S608 is YES, the processing proceeds to S606.

In a case where a result of determination in S608 is NO, the movable UE 303 uses the detection unit 208 to determine whether it has detected the fixed UE 301 (S609).

In a case where a result of determination in S609 is YES (for example, the movable UE 303 has detected the fixed UE 301), the movable UE 303 uses the synchronization processing unit 209 to operate in synchronization with the fixed UE 301 (S610).

In a case where a result of determination in S609 is NO, the processing proceeds to S611.

With the above-mentioned processing, in a case where the movable UE 303 has detected the fixed UE 301 in the network 300, it is possible for the movable UE 303 to be stably connected to the fixed UE 301, which makes it possible for the movable UE 303 to achieve stable synchronization in the physical layer.

That is, according to the present exemplary embodiment, in a case where information acquired from the fixed UE 301 is information indicating that the different communication apparatus is a predetermined type of communication apparatus that is to serve as the synchronization source, the fixed UE 301 that is the different communication apparatus from which the information has been acquired is set as the time synchronization source. As a result, it is possible for the movable UE to achieve stable synchronization.

Note that, in the network 300 that allows for PC5 communication, if UE that serves as a synchronization reference changes to, for example, the movable UE 304 with a change in signal intensity based on a relative positional relationship between the movable UE 303 and the fixed UE 301, it is difficult for the movable UE 303 to achieve stable synchronization in the physical layer. According to the present exemplary embodiment, the fixed UE 301 serves as the synchronization reference, which makes it possible for the movable UE 303 to achieve stable synchronization.

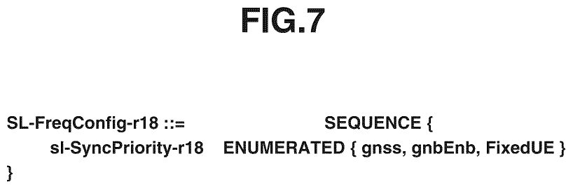

Note that sl-SyncPriority described in S603 and S607 in FIG. 6 is an internal parameter of the movable UE 303. The internal parameter (a setting content) may be preliminarily set in the communication apparatus 101 or may be set with use of the input unit 107. Additionally, the internal parameter may be set with reference to a content of sl-SyncPriority in the IE notified by different UE as illustrated in FIG. 7.

Further, the description has been given of the scan control unit 206 detecting the different communication apparatus that can serve as the synchronization source (the fixed UE 301 and the movable UE 304) within the predetermined range from the movable UE 303 in S602 in FIG. 6, but UE that is detected as the different communication apparatus that can serve as the synchronization source is not limited to the UE 301 and the UE 304. For example, the UE that is detected in S602 may be the fixed UE 301, the fixed UE 302, the movable UE 304, and the movable UE 305. In this case, since two pieces of fixed UE, the fixed UE 301 and the fixed UE 302, are detected in S604, a step of selecting one piece of fixed UE (for example, the UE 301) is provided between S604 and S605. In a case where there is a plurality of pieces of fixed UE and one piece of fixed UE is selected as a synchronization destination, for example, among the UE having sidelink sync. signal ID (SLSSID) of a value between 0 and 337, the UE with the smallest value is selected. Assume that the SLSSID is in accordance with SLSSID described in § 6.3.5 Sidelink information elements in 3GPP TS 38.331 V16.7.0. SLSSID stands for Sidelink Sync. Signal ID. SLSS is composed of two synchronization signals of a primary sidelink synchronization signal (PSSS) and a secondary sidelink synchronization signal (SSSS). The sidelink synchronization signal of SLSSID from 0 to 167 is used in a case where the sidelink synchronization signal is transmitted based on a synchronization timing of a base station apparatus. Additionally, the sidelink synchronization signal of SLSSID from 168 to 335 is used in a case where the sidelink synchronization signal is not based on the synchronization timing of the base station apparatus.

Information indicating Fixed UE in the above-mentioned exemplary embodiment is information indicating that the UE is immovable, but can be said as information indicating that the UE can stably serve as the synchronization source within an area owing to its immovability. In substitution for these pieces of information, it is possible to adopt a configuration in which the UE that wants to serve as the synchronization source notifies its surroundings of information indicating whether it wants to serve as the synchronization source. In this case, for example, a business operator who establishes a PC5 network is only required to set, at the time of installation of fixed UE, information indicating a desire to cause immovable UE to serve as the synchronization source in the fixed UE. Alternatively, for example, it is also possible to adopt a configuration in which information indicating a desire to serve as the synchronization source or information indicating Fixed UE is set as a factory default setting at the time of manufacturing a fixed type PC5 device including a mount and a fixing jig.

The above-mentioned network 300 is configured to include five pieces of UE, but the number of pieces of UE that constitute the network 300 is not limited to five. For example, there can be three or more pieces of fixed UE. In a case where there are three or more pieces of fixed UE, the number of pieces of UE that should serve as the time synchronization sources may be three or more. That is, in a case a plurality of pieces of information each indicating that the different communication apparatus is a predetermined type of communication apparatus that is to serve as the synchronization source is acquired, for example, the step of selecting one fixed UE is provided between S604 and S605 as described above. Then, the UE having SLSSID with the smallest value is selected from the plurality of pieces of acquired fixed UE. Alternatively, it is also possible to adopt a configuration in which the fixed UE, in a case of starting an operation of PC5 communication, preliminarily collects (preliminarily acquires) SLSSID transmitted from surrounding UE and sets its own SLSSID so as not to collide with other UE. Still alternatively, it is also possible to adopt a configuration in which, in a situation where a plurality of pieces of fixed UE having SLSSID with the smallest value exists, control is performed to perform negotiations among the pieces of fixed UE and change SLSSID of either one of the pieces of fixed UE. Additionally, a method of avoiding overlapping at the time of collision is not limited thereto. For example, the fixed UE having SLSSID with the smallest value uses a random number or the like to determine a change waiting time. With the elapse of the change waiting time, the fixed UE collects information regarding its surroundings to determine different fixed UE having SLSSID with the smallest value has changed its SLSSID. As a result of collection, if determining that the different fixed UE having SLSSID with the smallest value has not changed its SLSSID, the fixed UE resets its own SLSSID based on the random number or the like to try to avoid collision. In contrast, as a result of collection, if determining that the different fixed UE having SLSSID with the smallest value has changed its SLSSID, the fixed UE ends overlapping avoidance processing without changing its own SLSSID.

### Second Exemplary Embodiment

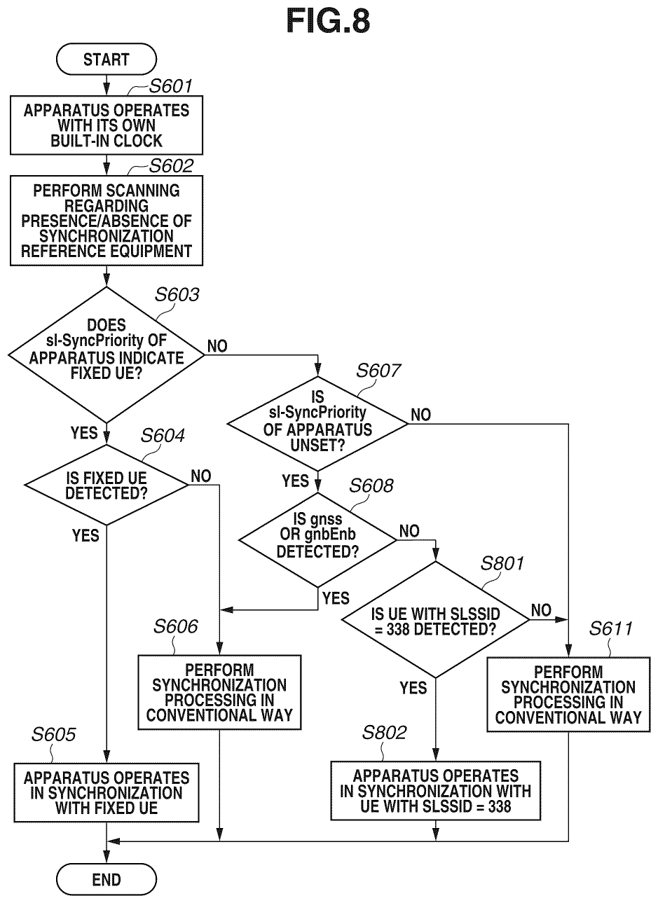

Next, a second exemplary embodiment of the present invention is described with reference to a flowchart in FIG. 8.

In the first exemplary embodiment, in a case where a result of determination in S608 in FIG. 6 is NO, the processing proceeds to S609, in which the movable UE 303 determines whether it has detected the fixed UE, and performs processing in S610 or S611 depending on a result of the determination. In the second exemplary embodiment, in a case where a result of determination in S608 in FIG. 6 is NO, subsequent processing is performed depending on whether SLSSID transmitted from each UE has a specific value. In the second exemplary embodiment, assume that SLSSID notified by UE that performs a stand-alone operation (the fixed UE, different UE that is connected to the fixed UE, or the like) to its surroundings has a value from 338 to 671. Additionally, in the present exemplary embodiment, assume that the fixed UE that wants to serve as a synchronization source sets its SLSSID at 338 and starts a PC5 operation. Note that execution of overlapping avoidance processing similar to that in the first exemplary embodiment makes it possible to prevent overlapping of pieces of equipment having SLSSID of the value 338. Additionally, for example, it is possible to adopt a configuration in which, in a case where pieces of fixed UE are connected to each other in a wired or wireless manner and achieve highly-accurate time synchronization on a regular basis, a plurality of pieces of fixed UE is permitted to give notification about SLSSID of the value 338. For example, in a case where highly-accurate time synchronization is achieved between the fixed UE 301 and the fixed UE 302, each of the fixed UE 301 and the fixed UE 302 sets SLSSID at 338 and performs processing of giving notification about the SLSSID.

In the second exemplary embodiment, the configuration of the communication apparatus 101 illustrated in FIG. 1 and the software functional configuration 201 illustrated in FIG. 2 are also used. Additionally, the network 300 illustrated in FIG. 3 is also used in the second exemplary embodiment, and the configuration of the fixed UE illustrated in FIG. 4 is also used in the second exemplary embodiment.

FIG. 8 is a flowchart describing synchronization processing executed by the communication apparatus 101 in the second exemplary embodiment. In the flowchart in FIGS. 8, S601 to S608 are identical to those in the first exemplary embodiment. Note that, in the present exemplary embodiment, assume that the communication apparatus 101 is the movable UE 305.

In a case where a result of determination in S608 is NO, in the present exemplary embodiment, the movable UE 305 determines whether SLSSID transmitted from (notified by) each UE indicates 338 (S801). The determination is made by the detection unit 208. In the present exemplary embodiment, assume that the fixed UE 302 is equipment having the SLSSID of the value 338 as described above. The SLSSID being from 338 to 671 means that it is UE that performs a stand-alone operation or achieves time synchronization with a source (synchronization source) through communication via two or more hops, which is communication that goes through different UE.

In a case where a result of determination in S801 is YES, the movable UE 305 operates in synchronization with the UE (fixed UE 302) having SLSSID of the value 338 (S802).

In a case where a result of determination in S801 is NO, the processing proceeds to S611. In a case where a result of determination in S608 is YES, the processing proceeds to S606.

As described above, even in a case where the movable UE 305 is out of a range of a more appropriate time synchronization source represented by the base station, the GNSS, and the like, it is possible for the movable UE 305 to be connected to fixed UE on a priority basis among a plurality of pieces of UE that performs a stand-alone operation or achieves time synchronization with a source via a plurality of hops. That is, it is possible for the movable UE 305 to be stably connected to the fixed UE 301 or the fixed UE 302 that gives notification about 338 as the SLSSID, and achieve stable synchronization in the physical layer.

Note that the fixed UE 301 and the fixed UE 302 can achieve highly-accurate time synchronization through direct communication. For example, the fixed UE 301 and the fixed UE 302 may be connected to each other by a wired local area network (LAN) and achieve highly-accurate time synchronization.

In a case where a plurality of pieces of fixed UE that achieves highly-accurate time synchronization exists, there is the following advantage. Even in a case where the movable UE 305 is out of a range of synchronization when seen from the fixed UE 301 (out of a range of the fixed UE 301), it is possible for the movable UE 305 to achieve synchronization with the fixed UE 302 within a range of synchronization (within a range of the fixed UE 301). The contents of the present exemplary embodiment are effective also in such a network 300, and it is possible to achieve stable synchronization in the physical layer.

### Third Exemplary Embodiment

In the above-mentioned exemplary embodiment, the communication apparatus 101 is the movable UE 303 or the movable UE 305. However, it is possible to apply the present invention also to a case where the communication apparatus 101 is the fixed UE 302.

The configuration of the communication apparatus 101 illustrated in FIG. 1 and the software functional configuration 201 illustrated in FIG. 2 are also used in a third exemplary embodiment. Additionally, the network 300 illustrated in FIG. 3 is also used in the third exemplary embodiment, and the configuration of the fixed UE illustrated in FIG. 4 is also used in the third exemplary embodiment.

A difference from the first exemplary embodiment will be described below with reference to FIG. 6.

In a case where the communication apparatus 101 is the fixed UE 302, the fixed UE 302 starts an operation with the built-in clock of the fixed UE 302 when the processing in FIG. 6 is started (S601).

In S602, assume that the fixed UE 302 performs scanning regarding the presence/absence of prioritized synchronization equipment and detects the fixed UE 301, the movable UE 304, and the movable UE 305.

In S603, the fixed UE 302 uses the prioritized synchronization source type checking unit 211 to determine whether sl-SyncPriority indicating a prioritized synchronization source of the fixed UE 302 is Fixed UE indicating the fixed UE.

In a case where a result of determination in S603 is YES, the fixed UE 302 uses the detection unit 208 to determine whether it has detected the fixed UE 301 (S604).

In a case where a result of determination in S604 is YES, the fixed UE 302 uses the synchronization processing unit 209 to operate in synchronization with the fixed UE 301 (S605).

In a case where a result of determination in S603 is NO, the movable UE 302 uses the prioritized synchronization source type checking unit 211 to determine whether sl-SyncPriority indicating the prioritized synchronization source for the fixed UE 302 has been unset (S607).

In a case where a result of determination in S607 is YES, the fixed UE 302 uses the detection unit 208 to determine whether it has detected gnss or gnbEnb (S608).

In a case where a result of determination in S608 is NO, the fixed UE 302 uses the detection unit 208 to determine whether it has detected the fixed UE 301 (S609).

In a case where a result of determination in S609 is YES, the fixed UE 302 uses the synchronization processing unit 209 to operate in synchronization with the fixed UE 301 (S610).

Each of processing in a case where a result of determination in S604 is NO, processing in a case where a result of determination in S607 is NO, processing in a case where a result of determination in S608 is YES, and processing in a case where a result of determination in S609 is NO is identical to corresponding processing in the first exemplary embodiment.

In this manner, even in a case where the communication apparatus 101 is the fixed UE 302 but if the fixed UE is set as the synchronization source equipment (S603: YES), the fixed UE 302 selects the fixed UE 301 as the synchronization source equipment. This makes it possible to achieve stable synchronization.

### Other Exemplary Embodiments

The present invention may be implemented by provision of a storage medium in which program codes of software that implements the above-mentioned functions are recorded to a system or a computer of an apparatus, and reading out and executing the program codes stored in the storage medium by the system or the computer (a CPU or an MPU) of the apparatus. In this case, the program codes themselves read out from the storage medium implement the above-mentioned functions according to the exemplary embodiments, and the storage medium that stores the program codes constitutes the present invention.

As the storage medium for supplying the program codes, it is possible to use, for example, a flexible disk, a hard disk, an optical disk, a magnetic optical disk, a compact disk read-only memory (CD-ROM), a compact disc recordable (CD-R), a magnetic tape, a nonvolatile memory card, a ROM, and a digital versatile disk (DVD).

Alternatively, the above-mentioned functions of the exemplary embodiments may be implemented not only by reading out and executing the program codes by the computer, but also by execution of part or all of actual processing by an operating system (OS) that operates on the computer based on an instruction of the program codes.

Furthermore, the program codes read out from the storage medium are written into a memory included in a function extension board installed in the computer or a function extension unit connected to the computer.

Alternatively, the above-mentioned functions may be implemented by execution of part or all of actual processing by a CPU included in the function extension board or the function extension unit based on an instruction of the program codes.

The present invention is not limited to the above-mentioned exemplary embodiments, and can be changed and modified in various manners without departing from the spirit and scope of the present invention. Thus, the claims are attached hereto to publicize the scope of the present invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to achieve stable synchronization in a network that adopts a sidelink communication method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus capable of performing sidelink communication, the communication apparatus comprising:
a detection unit configured to detect at least one different communication apparatus capable of serving as a synchronization source and capable of performing sidelink communication;
an acquisition unit configured to acquire predetermined information from each of the at least one different communication apparatus detected by the detection unit; and
a first setting unit configured to, in a case where a predetermined operation setting regarding a synchronization priority order has been made and the first setting unit determines that there is a different communication apparatus from which information indicating that the different communication apparatus is a predetermined type of communication apparatus that is to serve as the synchronization source has been acquired, among the at least one different communication apparatus, based on the predetermined information acquired by the acquisition unit, set the different communication apparatus from which the information has been acquired as a time synchronization source.

2. The communication apparatus according to claim 1,
wherein the acquisition unit is configured to acquire notification information in sidelink communication from each different communication apparatus,
wherein the first setting unit is configured to:
in a case where the notification information includes information indicating that the different communication apparatus is the predetermined type of communication apparatus, determine that the different communication apparatus is the different communication apparatus from which the information has been acquired; and
in a case where the predetermined operation setting has been made and the first setting unit determines that there is the different communication apparatus from which the information has been acquired, set the different communication apparatus from which the information has been acquired as the time synchronization source.

3. The communication apparatus according to claim 2, wherein the first setting unit is configured to set the synchronization source regardless of an intensity of an electric wave that reaches the communication apparatus.

4. The communication apparatus according to claim 1, further comprising a second setting unit configured to set an operation setting indicating the synchronization priority order among a plurality of operation settings including at least the predetermined operation setting and a second operation setting that is different from the predetermined operation setting.

5. The communication apparatus according to claim 4, wherein, in a case where the predetermined operation setting is made as the operation setting indicating the synchronization priority order, the first setting unit is configured to give priority to the different communication apparatus from which the information has been acquired over a public wireless base station and a satellite positioning system and set the different communication apparatus as the time synchronization source.

6. The communication apparatus according to claim 1, wherein, in a case where a plurality of pieces of the information indicating that the different communication apparatus is the predetermined type of communication apparatus that is to serve as the synchronization source is acquired, the first setting unit is configured to set a different communication apparatus having sidelink sync. signal ID (SLSSID) with a small value as the synchronization source.

7. The communication apparatus according to claim 1, wherein the predetermined type of communication apparatus is an immovable communication apparatus.

8. The communication apparatus according to claim 2, wherein the notification information includes information indicating that a communication apparatus that gives notification about the notification information is immovable.

9. The communication apparatus according to claim 4, wherein, in a case where the second setting unit sets an operation setting that is different from the predetermined operation setting as the operation setting indicating the synchronization priority order, the first setting unit is configured to set a public wireless base station or a global navigation satellite system (GNSS) as the time synchronization source.

10. The communication apparatus according to claim 9, wherein, in a case where the different operation setting is made as the operation setting indicating the synchronization priority order and the first setting unit fails to set the public wireless base station or the GNSS as the synchronization source, the first setting unit is configured to determine a different communication apparatus at a synchronization destination based on a value of the SLSSID and set the determined different communication apparatus as the synchronization source.

11. The communication apparatus according to claim 7, wherein, in a case where the communication apparatus is a communication apparatus that is installed in a fixed manner and is connected to the different, immovable communication apparatus via a wired local area network (LAN), the communication apparatus is configured to be synchronized with the different, immovable communication apparatus via the wired LAN.

12. A method of controlling a communication apparatus capable of performing sidelink communication, the method comprising:
detecting at least one different communication apparatus capable of serving as a synchronization source and capable of performing sidelink communication;
acquiring predetermined information from each of the at least one different communication apparatus that has been detected; and
in a case where a predetermined operation setting regarding a synchronization priority order has been made and information indicating that the different communication apparatus is a predetermined type of communication apparatus that is to serve as the synchronization source is acquired based on the acquired predetermined information, setting a different communication apparatus from which the information has been acquired as a time synchronization source.

13. A non-transitory computer-readable storage medium that stores a program for causing, when executed by a computer of a communication apparatus capable of performing sidelink communication to execute a method, the method comprising:
detecting at least one different communication apparatus capable of serving as a synchronization source and capable of performing sidelink communication;
acquiring predetermined information from each of the at least one different communication apparatus that has been detected; and
in a case where a predetermined operation setting regarding a synchronization priority order has been made and it is determined that there is a different communication apparatus from which information indicating that the different communication apparatus is a predetermined type of communication apparatus that is to serve as the synchronization source has been acquired based on the acquired predetermined information, setting the different communication apparatus from which the information has been acquired as a time synchronization source.
